(19) United States
(12) Patent Application Publication
(10) Pub. No.: US 2026/0154785 A1
(43) Pub. Date: Jun. 4, 2026

(54) AUTOMATED SCENE GENERATION SYSTEM WITH PRODUCT INTEGRATION

(71) Applicant: Target Brands, Inc., Minneapolis, MN (US)

(72) Inventors: Shubham Tripathi, Bengaluru (IN); Neha Dixit, Bengaluru (IN); Mudit Ranjan Pati, Bengaluru (IN)

(73) Assignee: Target Brands, Inc., Minneapolis, MN (US)

(21) Appl. No.: 19/272,563

(22) Filed: Jul. 17, 2025

Related U.S. Application Data
(60) Provisional application No. 63/727,466, filed on Dec. 3, 2024.

(51) Int. Cl. G06T 5/50; G06T 5/77; G06T 7/10

(52) U.S. Cl. CPC G06T 5/50; G06T 5/77; G06T 7/10; G06T 2207/20221

(57) ABSTRACT

Methods and systems for performing automated scene generation are described. One method for integrating products into generated scenes includes receiving a structure reference containing control features and positioned product images, and detecting control features from the structure reference to create a control image. The method further includes generating a scene using the control model and a text prompt, and segmenting products from both the structure reference and the generated scene to create product masks. The method includes replacing generated products with actual product images using the product masks, and applying inpainting to correct dimensional differences between the generated and actual products while preserving scene lighting and shadows.

### CROSS-REFERENCE TO RELATED APPLICATIONS

The present application claims priority from U.S. Provisional Patent Application No. 63/727,466, filed on Dec. 3, 2024, the disclosure of which is hereby incorporated in its entirety.

### BACKGROUND

Traditional approaches to lifestyle image creation (e.g., creation of images with product placements included therein) rely on commercial solutions such as Adobe Firefly and 3DS Max, requiring extensive manual intervention for structure creation, background generation, 3D product placement, and post-processing. These approaches necessitate significant time investment, with single image creation taking a number of hours, including significant time dedicated to background generation alone. Additionally, such conventional methods require creation of 3D product representations, taking days per product.

Concurrently, digital image generation systems increasingly utilize various computer vision and artificial intelligence models to create photorealistic scenes. These systems typically employ techniques such as stable diffusion, image segmentation, and inpainting to generate and modify digital imagery. Control mechanisms allow for structured generation of scenes based on textual descriptions and reference images, while segmentation models enable isolation and manipulation of specific image elements. Modern image generation pipelines incorporate multiple specialized models working in concert to achieve specific visual outcomes.

### SUMMARY

In accordance with example aspects, an automated scene generation system creates photorealistic lifestyle imagery featuring integrated product placements. The system employs a novel combination of generative AI and computer vision models to create a scene generation pipeline. The system implements a multi-step process using a control feature detector to generate control images, a diffusion model to generate scenes, and a segmentation model to handle product integration through mask extraction. The system performs an automated product replacement process, where the system overlays actual product images onto generated scenes while maintaining proper positioning and scale, using an inpainting model to automatically correct dimensional differences between generated and actual products. The system processes products sequentially to ensure accurate integration while preserving lighting conditions and shadow effects.

In a first aspect, a system for automated scene generation is disclosed. The system comprises a control feature detector configured to generate a control image from a structure image containing product images; a control net model configured to generate a scene based on a text prompt and the control image; a segmentation model configured to: extract a mask from the structure image; and extract a second mask from the generated scene; an inpainting model configured to correct dimensional differences between objects in the generated scene and the product images; wherein the system is configured to: overlay a product image onto the generated scene using the mask and the second mask; and process the generated scene to maintain lighting consistency and shadow effects on the product image within the generated scene.

In a second aspect, a method for automated scene generation is disclosed. The method comprises receiving a text prompt describing desired scene characteristics and a structure image containing product images; generating, using a control feature detector, a control image from the structure image; generating, using a control net model, a scene based on the text prompt and the control image; extracting, using a segmentation model: first masks from the structure image, and second masks from the generated scene; overlaying the product images onto the generated scene using the first masks and second masks; and sequentially processing each overlaid product using an inpainting model to correct dimensional differences between objects in the generated scene and the product images while maintaining visual effects within the generated scene.

In a third aspect, a method for integrating products into generated scenes is disclosed. The method comprises receiving a structure reference containing control features and positioned product images; detecting control features from the structure reference to create a control image; generating a scene using a control model and a text prompt; segmenting products from the structure reference and objects from the generated scene to create masks; replacing generated objects with product images using the masks; and applying inpainting to correct dimensional differences between the generated objects and the product images.

### BRIEF DESCRIPTION OF THE DRAWINGS

FIG. 1 illustrates an automated scene generation and product image integration platform including a control feature detector, a segmentation model, diffusion models, a control net model, and an inpainting model.

FIG. 2 is a flowchart illustrating a method for automated scene generation, including receiving scene and item images, creating and updating structure images, generating initial output images, and performing inpainting for product placement.

FIG. 3 shows a detailed technical flowchart that outlines the core models and processing workflow of the automated scene generation system according to a particular embodiment.

FIG. 4 illustrates example creation of a structure image, in accordance with aspects of the present disclosure.

FIG. 5 illustrates example insertion of item images into the structure image, in accordance with example aspects of the present disclosure.

FIG. 6 illustrates generation of a new structure image from the structure image and inserted item images from FIG. 5, and subsequent image generation using a diffusion model to generate a scene image that uses the new structure image as a control image.

FIG. 7 shows creation of an output image using an original image and the scene image generated in FIG. 6.

FIG. 8 illustrates a computing system implementation including processor, memory, network interface, and storage components for executing the automated scene generation system.

FIG. 9 illustrates a diagram of an example aspect of an inpainting process.

FIG. 10 illustrates a flowchart of an example method for using a scene generation application.

FIG. 11 illustrates an example user interface.

### DETAILED DESCRIPTION

As briefly described above, embodiments of the present invention are directed to an automated scene generation system. In examples, the automated scene generation platform creates photorealistic images featuring product placements. The platform can include a combination of generative AI and computer vision models to create a scene generation pipeline.

In example aspects, the platform uses a multi-stage pipeline. For example, the platform can use a control feature detector to generate control images, a diffusion model to generate scenes, and a segmentation model to handle product integration through mask extraction. The platform can perform an automated product replacement process, where the platform overlays actual product images onto generated scenes while maintaining proper positioning and scale, using an inpainting model to automatically correct dimensional differences between generated and actual products. The platform processes products sequentially to ensure accurate integration while preserving lighting conditions and shadow effects, significantly reducing the time and resource requirements compared to traditional methods that rely on manual intervention and 3D modeling.

In example aspects, the platform uses a descriptive prompt and a structure image as inputs. The prompt can describe the desired scene, including specifications for objects, lighting, shadows, and materials. The structure image comprises a structure reference for control features and product images positioned at desired locations.

In example aspects, the platform includes control mechanisms for maintaining visual consistency. For example, the diffusion model uses a control net to ensure that the generated scene maintains the perspective and relative positioning and size of items from the control image. The segmentation model ensures precise product placement, and the inpainting process preserves lighting conditions and shadow effects around integrated products. The platform also handles various interior settings and product types. Advantageously, the platform can produce high-quality photorealistic scenes while significantly reducing the time and computing resource requirements for rendering customized images depicting scenes with product placement.

In example aspects, regarding the inpainting process, when the diffusion model generates objects that may not exactly match the intended products, the segmentation model identifies the corresponding regions, and the inpainting process analyzes edge pixels to ensure appropriate dimensioning while maintaining visual consistency. In some embodiments, a custom inpainting model may be used to replace images generated by the diffusion model with image data more closely correlated to the item sought to be incorporated into the scene. As such, this step of segmentation and inpainting can handle product integration.

Generating computer-based images that depict scenes can present several technical challenges, some of which can be addressed with the platform disclosed herein and the components associated therewith. One challenge is accurately simulating the physical properties of light, materials, and environments. Moreover, scene generation involves semantic and compositional challenges. For example, creating a scene that is not only visually accurate but also contextually coherent requires precise placement of objects, appropriate scaling, and consideration of spatial relationships. For example, generating a dining room scene requires understanding that chairs should face a table, lighting should match the time of day, and objects should not intersect unnaturally. Additionally, generating scenes dynamically or from prompts compounds the challenge, as it necessitates interpreting human input and translating it into visually coherent outputs. Nevertheless, through the use of the multi-stage pipeline disclosed herein, the platform can address these challenges to generate photorealistic scenes that are customized to include certain objects embedded therein.

Aspects of the present disclosure provide various technical advantages. For example, embodiments disclosed herein provide an improvement to the field of computer image generation. For instance, at least the following features demonstrate such a technical improvement: reduction of manual 3D modeling requirements; automated handling of lighting and shadow effects; preservation of spatial relationships and scale throughout processing; and sequential processing capability for placing multiple products in a scene while preserving scene integrity.

Moreover, the integration of multiple AI models working in concert provides various advantages. For example, by implementing a multi-stage pipeline combining control feature detection, diffusion models, and segmentation models, the system can automatically and quickly generate photorealistic images. Moreover, although the pipeline can automate various tasks, a user is still able to select particular product images to integrate into an image, and the user is also able select a structure and style of the scene that is generated. As a result, user options and photo quality are maintained or improved while the speed to generate photos of scenes is greatly reduced.

Yet still, the platform advantageously handles product integration through automated segmentation and inpainting processes. For example, the platform can precisely identify product regions in both structure images and generated scenes, replace generated object images with corresponding actual product images, and adjust for dimensional differences through an inpainting process. This automated approach can preserve visual consistency, lighting conditions, and shadow effects throughout the scene, thereby ensuring visual coherence without requiring manual post-processing or extensive 3D product modeling that traditionally takes days per product.

Yet still, the platform's sequential processing capability represents another technical advantage, allowing multiple products to be accurately integrated into a single scene while maintaining overall scene integrity. For example, the platform can ensure that generated scenes maintain perspective and relative positioning from control images, while also enabling precise product placement of multiple different products in the generated scene. Moreover, in certain contexts, the platform can provide significant advantages for real-time product visualization and marketing adaptability. For example, the platform's ability to generate different scenes with products integrated therein can enable generation of multiple scene variations showing the same product in different contexts or with different complementary products, allowing for expanded photo options and dynamic testing and utilization of generated images. Furthermore, the platform's ability to control certain inputs, such as template scenes, prompts, and model processing parameters, can enable visual consistency across different scenes. As will be understood, these are only some of the advantages that may be provided by aspects of the present disclosure.

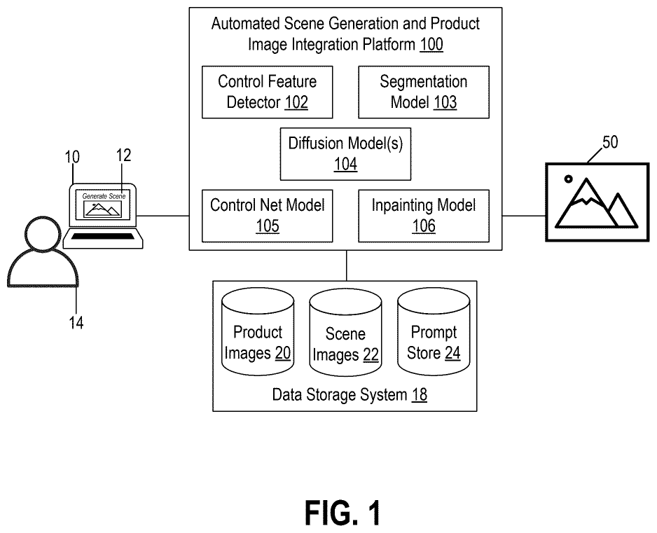

FIG. 1 illustrates an environment in which aspects of the present disclosure may be implemented as part of automated scene generation. FIG. 1 includes an automated scene generation and product image integration platform 100, a device 10, a client application 12, a user 14, and a data storage system 18. Components of FIG. 1 may be communicatively coupled via a network or a combination of networks. Certain components of FIG. 1 may be communicatively coupled via the internet. In some embodiments, one or more components of FIG. 1 may be associated with a common entity. For example, each of the client application 12, platform 100, and storage system 18 may be provided by the same entity, thereby enabling an integration of otherwise disconnected systems and data to generate scenes. In an example, the entity is a retailer. In some embodiments, however, one or more components of FIG. 1 may be associated with a third party. For example, the client application 12 may be a third-party application that calls an application programming interface (API) of the platform 100 to generate scenes.

The platform 100 includes several components that work together to generate photorealistic scenes with integrated product images. In some embodiments, the platform 100 is implemented in a cloud-based environment. In some embodiments, components of the platform 100 are distributed across different computing systems, and the platform 100 includes interfaces via which data is exchanged across the different computing systems. In the example shown, the platform 100 includes a control feature detector 102, a segmentation model 103, diffusion models 104, a control net model 105, and an inpainting model 106. The platform processes product images 20 and scene images 22 through these components to generate the final output.

The control feature detector 102 is configured to generate control images from structure images containing product images. The control feature detector 102 may also generate structure images. In some embodiments, a control image and a structure image are a same type of image (e.g., an edge image, a key point image, a sketch, etc.) but are used at different steps in a scene generation pipeline. For example, a structure image may be generated based on an initial input image, or template image, and may not include an outline or other representation of specific products. A control image, by contrast, may include an outline or other representation of specific products and may be provided to the control net model 105 to generate a scene.

In some embodiments, the types of images generated by the control feature detector 102 depend on the types of images used by the control net model 105 to generate images. For example, the control feature detector 102 may implement a vision processing algorithm for receiving an image and converting it into a different format of image to be input into the control net model 105. In some embodiments, the control feature detector 102 generates black-and-white or gray-scale outlines of images. In some embodiments, the control feature detector 102 is a Canny edge detector that generates canny images. In some embodiments, the control feature detector 102 detects key points, and the control image comprises a map with key points.

The segmentation model 103 can be a model that performs pixel-wise classification of images by partitioning them into semantically meaningful regions, such as regions with products or with objects to be replaced by products. These models output a segmentation mask where each pixel is assigned a class label, enabling fine-grained understanding of scene content. The segmentation model 103 can be configured to identify products and other relevant items in scenes and generate a mask for such products or items. In some embodiments, the segmentation model 103 handles product integration by extracting product masks from both structure images and generated scenes. The segmentation model 103 can comprise a convolutional neural network (CNN). The segmentation model 103 may be implemented as, for example, a Segment Anything Model (SAM); however, other examples may be used as well.

The control net model 105 generates scenes based on text prompts and control images, while working in conjunction with the diffusion models 104. In some embodiments, the control net model 105 comprises the diffusion model 104, or they be used in conjunction; accordingly, as used herein, reference to the control net model 105 can refer to the combination of the control net model 105 with the diffusion model 104, or to the control net model 105 separately, depending on the context. The diffusion model 104 can generate images by reversing a gradual noising process, transforming random noise into coherent outputs through a series of denoising steps. Trained via denoising score matching, it captures the data distribution by modeling the conditional probabilities of less-noisy data given noisier versions across multiple timesteps.

In some embodiments, the control net model 105 guides the denoising process of the diffusion model 104. For example, the control net model 105 can guide the output using structural inputs like edge maps, pose estimations, depth maps, segmentation masks, or other control images output by the control feature detector 102. In some embodiments, the control net model 105 comprises trainable layers that are added to a pre-trained diffusion model 104, allowing the control net model 105 to interpret control inputs while preserving the quality and diversity of the diffusion model 104. This architecture facilitates precise and repeatable generation of images aligned with specific structural constraints. In some embodiments, the control net model 105 is a Control Net model that works in conjunction with a Stable Diffusion model.

The inpainting model 106 corrects dimensional differences between objects in the generated scene and actual product images. For example, the platform 100 may overlay an actual product image over a corresponding object in the generated scene, but the dimensions may not exactly align, causing visual inconsistencies in the scene. The inpainting model 106 can modify the image to correct these inconsistencies. In some embodiments, the inpainting model 106 overlays masks generated by the segmentation model 103 to identify dimensional differences between a generated product image and an actual product image. Based on differences in the masks, the inpainting model 106 identifies pixels of the generated image to paint and then changes the picture color to match the generated scene in which the actual product image has replaced the generated product image. Additionally, the inpainting process handles any dimensional differences between generated and actual products while preserving lighting conditions and shadow effects throughout the scene. In some embodiments, the inpainting process may analyze edges of the image region that is being inpainted, and assign average or nearest neighbor pixel values to ensure appropriate dimension usage.

The data storage system 18 may include various components for storing and managing data. For example, the data storage system 18 may include storage devices that provide physical space for data; interfaces that connect the storage devices to other devices; and storage management software, which handles tasks like data organization, access control, and ensuring data integrity. In some embodiments, the data storage system 18 includes one or more query engines for retrieving data from datasets stored in databases. In some embodiments, aspects of the data storage system 18 may be distributed while other aspects may be centralized. In some embodiments, the data storage system 18 can be on-premises or cloud-based, or a hybrid of both. In some embodiments, part of the data storage system 18 may be internal to an entity associated with the platform 100 whereas part of the data storage system 18 may be external relative to that entity. In some embodiments, the data storage system 18 includes a plurality of different data storage systems. In the example shown, the data storage system 118 includes product images 20, scene images 22, and a prompt store 24.

The product images 20 can include images of products to be integrated into scenes generated by the platform 100. The product images 20 may be images from a product catalog associated with a retailer. Each product may correspond with a plurality of images from the product images 20. The product images 20 can include images captured by a camera and uploaded to the system 18, images generated by a computing system, or both. In some embodiments, the product images 20 include not only an image of products but also contextual data associated with such products, such as complementary products or a situation in which a product is used; in such instances, multiple objects associated with a product can be integrated into a scene. In some embodiments, the product images 20 include 3D images or models representing products. For each product in the product images 20, the data storage system 18 may include text information about the product, such as, for example, one or more of a name, identifier, description, or review of the product. In some instances, such text data can be incorporated by the platform 100 into a prompt to be used by the control net model 105.

The scene images 22 include images of scenes that include products integrated therein and images of scenes without products integrated therein. The scene images 22 can include images captured by cameras, images generated by computers, or both. For instance, the scene images 22 can include AI-generated images. The scene images can include a set of template images that are used as a basis for the platform 100 as part of generating scene images with products integrated therein. In some embodiments, the scene images 22 can include 3D image features. In some embodiments, the user 14 can select a scene from among the scene images 22 as a basis for a scene to be generated by the platform 100.

The prompt store 24 includes prompts used by the platform 100 to generate scenes. In some embodiments, the prompts of the prompt store are provided to the control net model 105 to generate scenes. In some embodiments, the prompts describe scene characteristics including at least one of: object specifications, lighting requirements, shadow characteristics, and material properties. In some instances, the prompts refer to one or more of the control image generated by the control feature detector 102 or to the product to be integrated into the scene. In some embodiments, the prompts can include descriptions of products from a product catalog. For example, for a given product offered for sale by a retailer, an image of the product can be stored in the product images 20 and a description, or other text data associated with the product (such as a review, classification, title, etc.), can be stored in the prompt store 24. When generating a scene depicting the product, the platform 100 can retrieve the image and text data associated with the product from the data storage system 18. In some embodiments, the prompt store 24 includes scene-specific prompts. For example, a scene from the scene images 22 may include a prompt that describes how it is to be modified to integrate certain products.

The device 10 is a computing device that can be used by the user 14 to interact with the platform 100. The device 10 may be a phone, laptop, tablet, smart device, virtual reality headset, or other computing system. The device 10 can access the application 12. For example, the application 12 me be downloaded on the device 10, or the device 10 may include a web browser or other application for accessing the application 12.

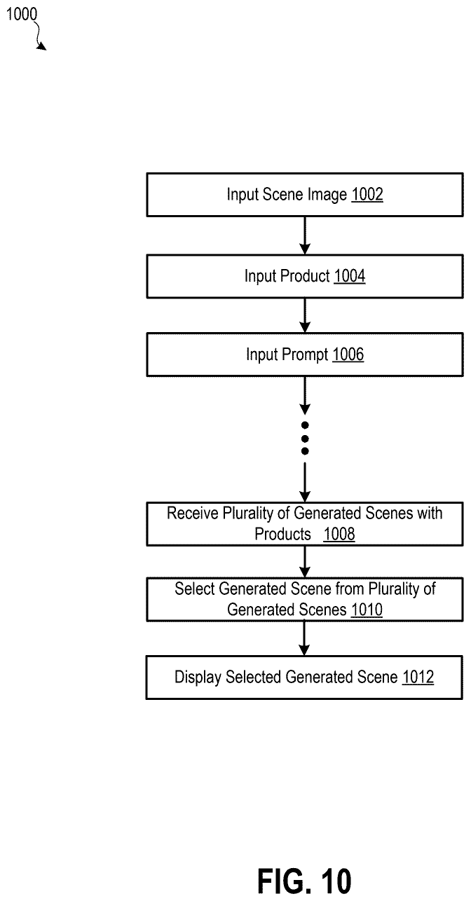

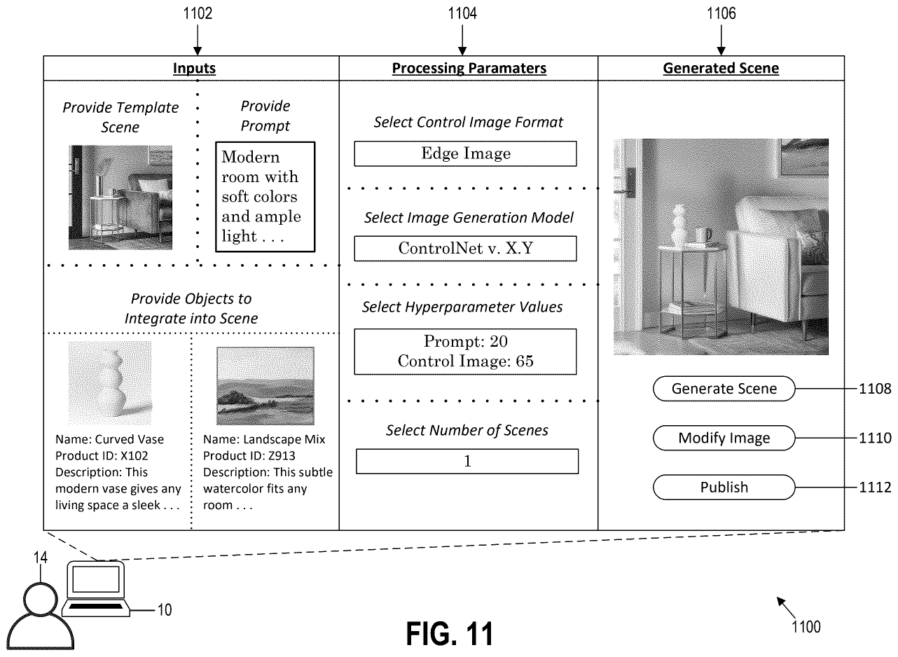

The application 12 can be a client application that uses the platform 100 as a service for generating scenes. The application 12 can be a mobile application, a web application, or another type of application. In some embodiments, the application 12 calls APIs exposed by the platform 100 to generate scenes with integrated product placement. In some embodiments, the application 12 is provided by and used by a third party relative to the platform 100, whereas in some embodiments, the application 12 and the platform 100 are provided by the same entity. Using the application 12, the user 14 can generates scenes with selected products integrated therein. Example features of the application 12 are further described below in connection with FIGS. 10-11.

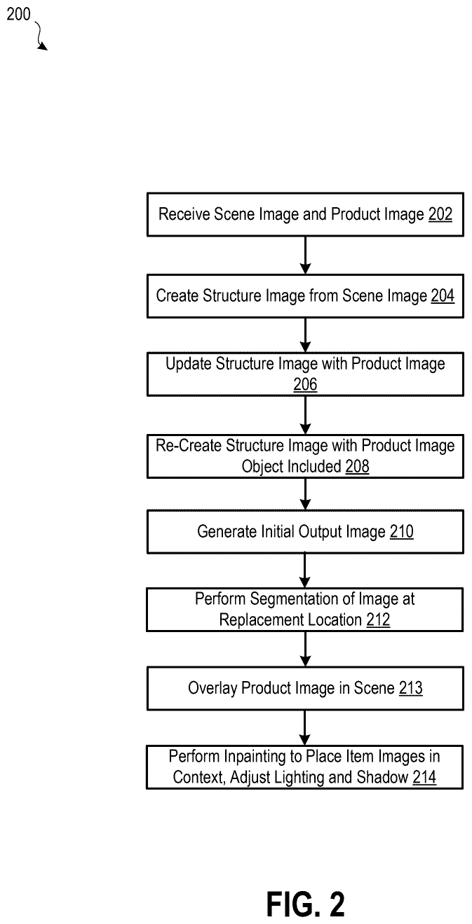

FIG. 2 depicts a flowchart illustrating a method 200 for automated scene generation. The method 200 may be performed, for example, using the platform 100 described above in conjunction with FIG. 1. Although the method 200 is described as being performed by the platform 100, and components thereof, it is to be understood that, depending on the embodiment, different components can perform steps of the method 200. Although the example of FIG. 2 is described as being performed to integrate a single product into a scene, the method 200 can be applied to integrate a plurality of different products, or other items such as logos or text, into the same scene. Moreover, the method 200 can be re-applied to generate additional scenes.

In the example embodiment shown, the method 200 begins with the platform receiving both a scene image and a product image as initial inputs (step 202). For example, the platform 100 can retrieve a product image from the product images 20 and a scene image from the scene images 22. In some embodiments, a user selects one or more of the product image or the scene image, or an identifier associated with the product image or the scene image. In some embodiments, the platform 100 generates the product image or the scene image. For example, the platform 100 can query an image generating AI service to generate the scene image based on a prompt received form a user, based on text associated with the product (e.g., a description), based on a scene style encoded into the platform 100 by an administrator, or based on a combination thereof.

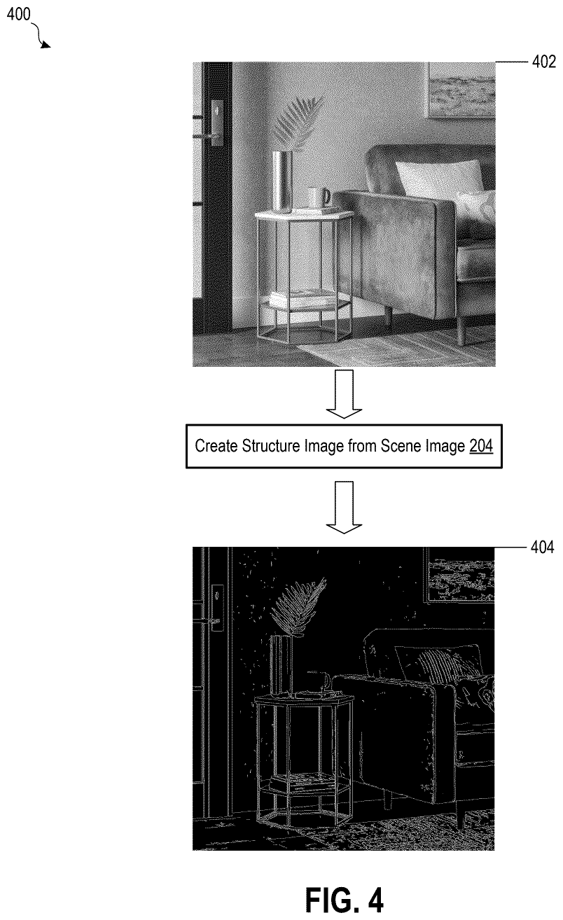

After receiving the initial inputs, the platform 100 proceeds to create a structure image derived from the scene image (step 204). For example, the platform 100 can apply the control feature detector 102 to generate the structure image. The structure image can comprise a structure reference that is later used by the control net 105 to generate scene. The structure reference can include edges or other visual indicia that indicate relative positioning of certain objects in the scene. In some embodiments, the structure image is the structure reference, and vice-versa. For example, the control feature detector 102 can generate an edge image or other image format of the scene image as the structure image including structure reference. Following the step 204, the scene image may not have any products integrated therein; however, the structure image may include objects corresponding to products that are to be integrated into the scene. In some examples, this structure image serves as a reference point for the control features and provides the basic framework for product placement within the scene. An example input and output of the step 204 is illustrated in FIG. 4.

The method 200 further includes updating the structure image by incorporating the item images (step 206). During this stage, the platform 100 positions the product images at their desired locations within the structural framework while maintaining proper spatial relationships and scale. For example, the product image received at the step 202 may be injected into the structure image generated at the step 204. In some instances, the product image replaces a corresponding object within the structure image. For example, if the product is a vase, then a vase or other container in the structure image can be replaced by the image of the vase. In some instances, however, there need not be a corresponding object in the structure image to insert the product image, but the product image can be inserted into the structure image. In some embodiments, the product image can be automatically inserted into the structure image by automatically applying an object detection model to identify a location at which the object is to be inserted and by editing the image to include the product image. In some embodiments, inserting the product image into the structure image is performed manually.

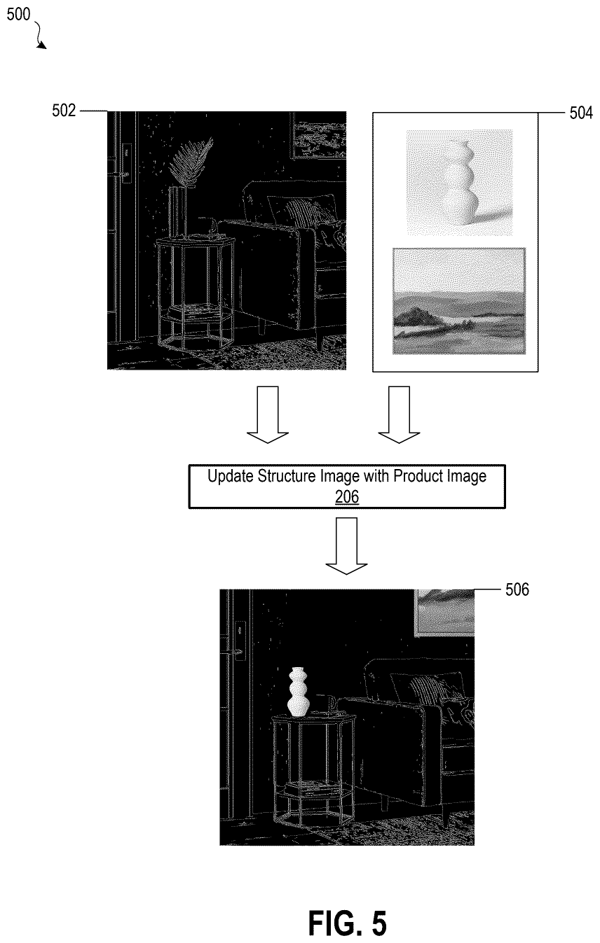

When the product image is inserted into the structure image, it can be manipulated, either automatically or manually, such that it fits the structure image. For example, one or more of the dimensions, rotation, or skew of the product image can be modified to fit into a position of the structure image. This updated structure image combines both the structural elements and the positioned products to create a comprehensive reference for the generation process. In addition to products, the structure image may be modified to include other objects that can be integrated into the scene. Such objects can include text, logos, or other objects to be inserted into the generated scene. An example input and output of the step 206 is illustrated in FIG. 5.

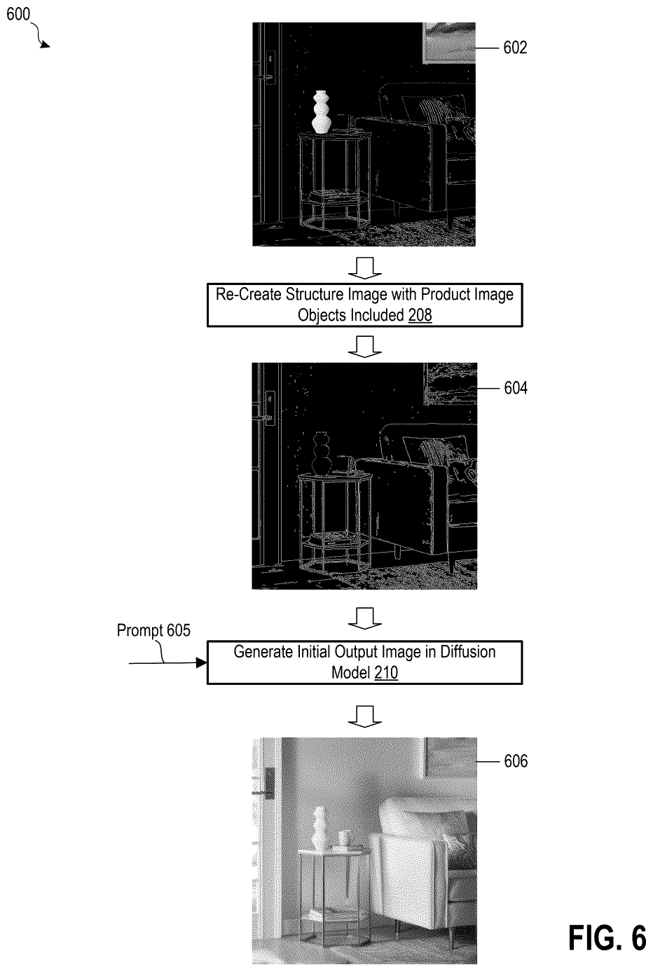

In the example shown, the method 200 further includes recreating the structure image that now includes the item image objects (step 208). For example, the control feature detector 102 can generate a control image using the updated structure image generated at the step 206. For example, in the updated structure image, the product image inserted into the structure image may not have a same format as other portions of the structure image. For example, the product image may be in color and the rest of the structure image may be in black and white, or the product image may be overlayed on the structure image, but they may not yet form a unitary file that can be provided to the control net model 105. Accordingly, the control feature detector 102 can regenerate the structure image to create the control image. This re-creation process can ensure that all product placements are properly integrated into the structural framework while maintaining the desired positioning and relationships between elements. An example input and output of the step 208 is illustrated in FIG. 6.

In the example shown, the method 200 further includes generating an initial output image using the diffusion model (step 210). This step may include processing the re-created structure image via the control net model 105 that is used as a constraint on the diffusion model 104. For example, the diffusion model 104, constrained by the control net model 105, generates a photorealistic scene based on both the structural elements and the positioned products in the control image generated by the control feature detector 102.

Furthermore, the control net model 105 can receive a prompt from the prompt store 24 that further guides generation of the scene. That is, the diffusion model 104 works in conjunction with the control net model 105 to ensure that the generated scene maintains consistency with the original structure while incorporating the specified product placements. However, the initial scene generated at the step 210, while preserving structural consistency of objects in the scene, may not include the actual product photos, as such photos may be removed by the control feature detector 102 at the step 208. Nevertheless, the generated scene can be modified to include actual product photos, as described, for example, by the steps 212 and 214. An example input and output of the step 210 is illustrated in FIG. 6.

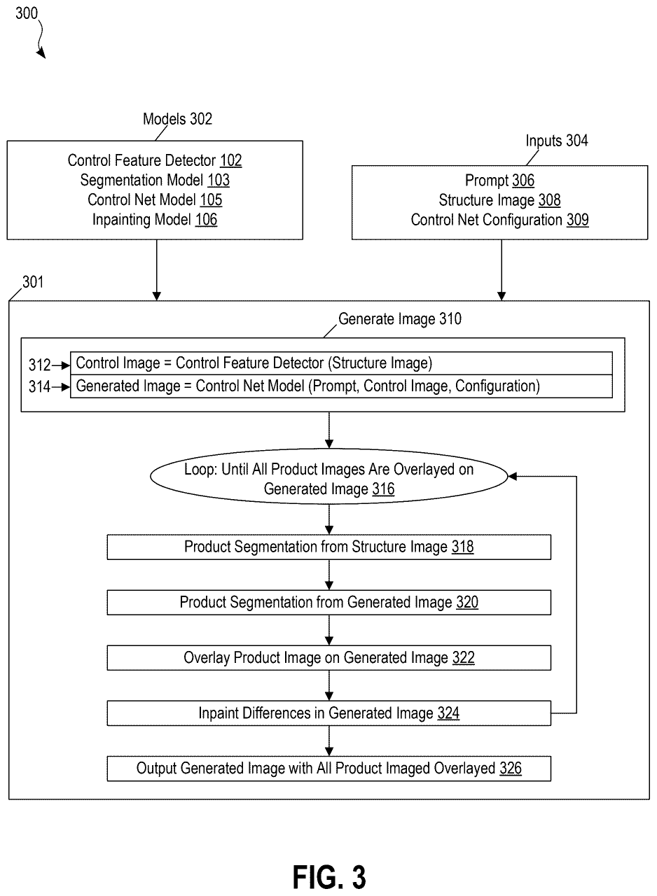

In the example shown, the method 200 further includes performing segmentation on the generated output image to identify regions of the image that correspond to the object to be placed in the image (step 212). As noted, a diffusion model that is restricted in output by a control net may generate an object in accordance with the control structure, but that object may not exactly correspond to the object that is intended to be placed in the scene. The segmentation model 103 may therefore be used to identify the region corresponding to the object in the generated scene to be replaced by the actual product image. Moreover, the segmentation model 103 may identify a location of the actual product image in the updated structure image generated at the step 206. As a result, two masks can be generated, a first mask corresponding to the product in the updated structure image and a second mask corresponding to an object or location in the generated scene that is to be replaced by the product image. These operations are further described in connection with the steps 318-320 of FIG. 3.

In the example shown, the method 200 includes overlaying the product image into the generated scene (step 213). For example, the platform 100 can insert the product image into the generated scene at the location identified during the segmentation process of step 212. In some embodiments, the product image can be manually or automatically inserted, using a segmentation mask determined at the step 212, into an identified location of the generated scene. For example, the platform 100 may combine all pixels of the generated image except the pixels representing the object segmented in the step 212 with only the pixels of the structure image that represent the product identified in the step 212. By doing so, the actual product image, which is present in the structure image 308 but not in the image generated at the step 310, is inserted into the generated scene. Additionally, inserting the product image into the scene can include adjusting a lighting and shadow discrepancies that exist. As an example, once the product image is inserted into the image, a user may manually adjust a shading on the product to fit the context of the generated scene. As another example, once the product image is inserted into the image, the inpainting process described in connection with the step 214 can automatically alter shading or lighting on the inserted product image to match the surrounding scene. In some embodiments, links can also be embedded into the scene that lead to additional information for the products. For example, if a user selects a product embedded in a scene, the application displaying the scene may automatically display additional information about the product or lead to a purchasing system for ordering the product.

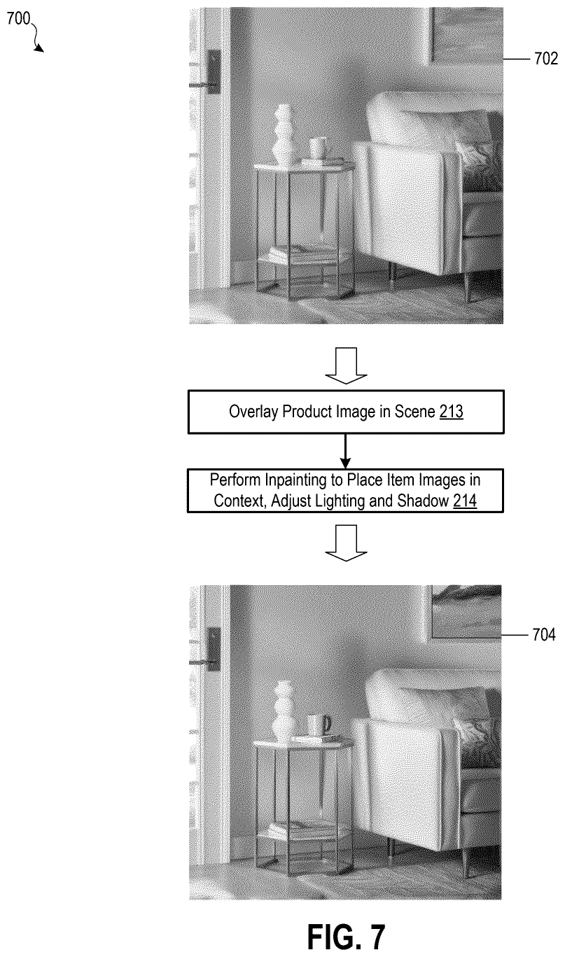

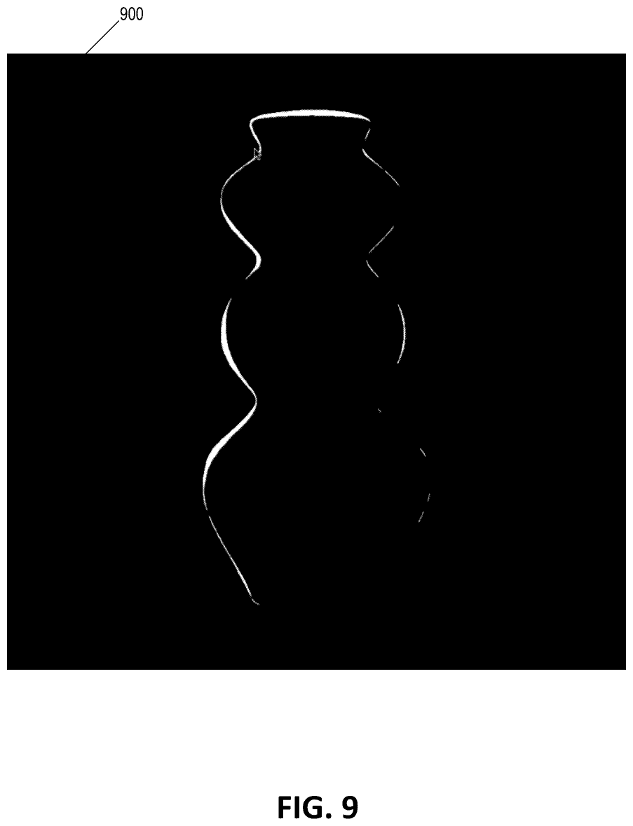

In the example shown, the method 200 includes performing an inpainting process to place the product images into the generated scene (step 214). For example, the inpainting process handles any dimensional differences between generated and actual products while preserving lighting conditions and shadow effects throughout the scene. The inpainting process may analyze edges of the image region that is being inpainted, and assign average or nearest neighbor pixel values to ensure visual consistency between the product and the generated scene. An example of inpainting is described in connection with the step 324, and an example of pixels that are modified during the inpainting process is shown in FIG. 9. An example of an input and output of the steps 213-214 is illustrated in FIG. 7.

FIG. 3 illustrates a flowchart 300 that outlines models and processing workflow of the automated scene generation system according to a particular embodiment. The example of FIG. 3 illustrates a pipeline 301 that can be performed using components of the platform 100 described above in connection with FIG. 1. In some embodiments, operations performed in the pipeline 301 are automated. As shown, the models 302 can be used as part of the pipeline 301. As shown, the inputs 304 can be processed by the pipeline 301 to generate a scene with products integrated therein.

In the example shown, the models 302 that can be used as part of the pipeline 301 can include one or more of the following: the control feature detector 102, the segmentation model 103, the control net model 105, and the inpainting model 106. For example, the control net model 105 controls the output of generative text-to-image models using control features. The segmentation model 103 handles product segmentation and mask extraction. In an example, the control feature detector 102 processes elements to perform edge detection. The inpainting model 106 can correct dimensional variations while preserving scene consistency.

In the example shown, the inputs 304 can include a prompt 306 that provides a description of desired scene characteristics. Additionally, the inputs 304 may include a structure image 308 containing product placements and structural elements that serve as reference for the control features, such as an image generated at the step 206 of FIG. 2. Additionally, the inputs 304 can include control net configurations 309. The control net configurations 309 can be hyperparameter values that are used by the control net model 105 as part of generating a scene. Two examples of such hyperparameters are weights used by the control net model 105 for following a prompt and the structure image. For example, the higher the weight given to the prompt, the more the control net model 105 will attempt to generate an image that matches the prompt. Similarly, the greater the weight given to the structure image, the more the control net model 105 will attempt to generate an image that follows the structure image.

The pipeline 301 includes a step for generating an image (step 310). For example, the platform 100 can generate an image of a scene that does not yet have actual product images integrated therein. In the example shown, the step 310 includes two sub-steps. For example, the platform 100 can generate a control image (step 312). Generating the control image can include inputting the structure image 308 into the control feature detector 102, example aspects of which are described in connection with the step 208 of FIG. 2. Furthermore, the platform 100 can generate an initial image for the scene (step 314). For example, the platform 100 can input the prompt 306, the control image generated at the step 312, and the control net configuration 309 into the control net model 105, which can generate a scene using these inputs, example aspects of which are described above in connection with the step 210 of FIG. 2.

In the example shown, the platform 100 can repeatedly perform operations to insert actual product images and images of other objects into the generated image, as indicated by the loop 316. For example, the platform 100 can repeat the steps 318-324 until all selected products have been integrated into the generated scene. For example, the flowchart demonstrates an iterative processing loop for handling product integration, where for each product, the system extracts segmentation masks from both the structure image and generated image using the segmentation model, and input points are generated for precise mask extraction. A product overlay operation may then be performed using the extracted masks, and an inpainting model processes dimensional differences between generated and actual products.

In the example shown, for a given product of one or more products to be integrated into a scene, a segmentation of the product from the structure image can be performed (step 318). For example, the segmentation model 103 can identify the product in the structure image 308 and generate a mask that represents the location of the product within the structure image.

In the example shown, the segmentation model 103 can identify an object in the image generated at the step 310 (step 320). For example, the segmentation model 103 may identify an object that corresponds to the product to be inserted into the image. The segmentation model 103 can generate a mask that represents the location of this product within the generated image.

In the example shown, the platform 100 can overlay an actual product image on the generated image (step 322). To do so, the platform 100 may use the masks generated at the steps 318 and 320. For example, the platform 100 may combine all pixels of the generated image except the pixels representing the object identified at the step 320 with only the pixels of the structure image that represent the product identified at the step 318. By doing so, the actual product image, which is present in the structure image 308 but not in the image generated at the step 310, is inserted into the generated scene.

In the example shown, the platform can inpaint differences in the generated image (step 324). For example, the product masks generated by at the steps 318 and 320 may not have exactly the same dimensions for the masked products. For instance, the control net model 105 may not always strictly adhere to object boundaries in the control image. Accordingly, the platform 100 can determine dimensional differences between the masks generated at the steps 318 and 320, thereby identifying mask image differences between the structure image and generated image. To do so, the platform 100 may subtract the masks. Thereafter, the platform 100 may input the mask image differences and the generated image having the product inserted therein into the inpainting model 106. The inpainting model 106 may then determine colors for pixels of the mask image differences, such as by, for example, taking an average color value of nearby pixels or performing other inpainting image modification techniques. Following the step 324, the platform 100 can return to the step 316 to thereafter repeat the steps 318-324 to insert another product into the image generated at the step 310.

In response to determining that there are no further products to insert into the generated image, the platform can output the generated image that has all product images embedded therein (step 326). For example, the generated image can be output to an application that called the platform 100 to generate a scene or to a user that provided, for example, one or more of the inputs 304.

In example implementations, the flowchart 300 illustrates that the platform 100 may utilize a sequential processing approach, where each item is handled individually to ensure proper integration while maintaining lighting consistency and shadow effects throughout the scene. Additionally, the flowchart 300 also shows how the control net configuration manages scene generation parameters to maintain visual consistency across the entire process. The final output, as depicted in the flowchart, represents a fully processed scene with all products properly integrated, demonstrating the system's ability to generate photorealistic lifestyle imagery while significantly reducing the time and resource requirements compared to traditional methods.

FIGS. 4-7 illustrate the detailed progression of the automated scene generation process through multiple stages of product integration and refinement.

FIG. 4 demonstrates a logical flow 400 depicting the initial creation of a structure image 404 that serves as the foundation for scene generation. In this example, the platform 100 creates a structure image 404 from a scene image 402, as described in connection with the step 204 of FIG. 2. In this example, the scene image 402 depicts a template of a scene without any products placed therein. The platform applies the control feature detector 102 to the scene image 402 to generate the structure image 404. The structure image 404 can be a Canny image, an edge image, or another representation of the scene image 402. The structure image 404 provides a reference for control features and product placement locations, requiring only basic structural elements to guide the subsequent generation process. FIG. 4 illustrates how the system can work with minimal input while maintaining precise control over the final scene composition.

FIG. 5 illustrates a further logical flow 500 in which the insertion of product images into the structure image is performed. The logical flow 500 continues from the logical flow 400 of FIG. 4. In this example, the product images 504 are placed into the structure image 502 to create an updated structure image 506, as described in connection with the step 206 of FIG. 2. In particular, as illustrated, product images 504 are strategically placed at desired locations within the structural framework. For example, the vase in the product images 504 replaced the vase on the table in the structure image 502, and the painting in the product images 504 replaces the painting in the structure image 502. The platform 100 maintains proper positioning and scale during this insertion phase. For example, the platform 100 may automatically scale or rotate the product images 504 to ensure they are visually in accordance with other features of the structure image 502. As another example, the product images 504 can be manually manipulated prior to being placed into the structure image 502. Among other things, FIG. 5 demonstrates that multiple product or item images can be positioned within the same structure image while maintaining proper spatial relationships.

FIG. 6 illustrates a further logical flow 600 that depicts example aspects of generating a scene with product placement. The logical flow 600 continues from the logical flow 500 of FIG. 5. In the example shown, the platform 100 converts the updated structure image 602 into the control image 604, as described in connection with the step 208 of FIG. 2. Thereafter, the platform 100 generates an initial output image 606 using the control image 604 and the prompt 605, as described in connection with the step 210 of FIG. 2. As shown in the example of FIG. 6, the platform 100 performs a two-stage process including generation of a new structure image that incorporates both the original structure image and the inserted item images from FIG. 5, as well as subsequent image generation process using a diffusion model, where the new structure image serves as a control image. The example of FIG. 6 highlights how the control net model maintains consistency between the structure image and the generated scene while incorporating the specified product placements.

FIG. 7 illustrates a logical flow 700 that depicts further example aspects of generating a scene with product placement. The logical flow 700 continues from the logical flow 700 of FIG. 7. In the example shown, the platform 100 converts the initial output image 702 into the generated scene 704, as described in connection with the steps 213-214 of FIG. 2 and in connection with FIG. 3.

In the example shown, the platform 100 replaces three objects in the initial image 702 to create the generated scene 704. The platform 100 replaces the vase on the table, the cup on the table, and the painting in the upper-right corner of the initial output image 702. To do so, the platform 100 may perform operations described in connection with FIG. 3, such as, for each of the items, generating masks using the initial output image 702 and the updated structure image 602, replacing the object in the initial output image 702 with the image in the updated structure image 602, and performing inpainting to adjust for any dimensional differences between objects. Accordingly, FIG. 7 specifically illustrates the segmentation and inpainting process, showing how the system first segments to identify the items to be removed from the output image, and overlays the appropriate product image thereon while performing dimensional corrections and maintains lighting consistency.

Referring to FIGS. 4-7 specifically, the progression demonstrates several technical innovations of the system, including an ability to maintain structural consistency between initial input and final output images, sequential processing of multiple products while preserving lighting and shadow effects, automated correction of dimensional differences between generated and actual product, and preservation of spatial relationships and scale across all processing stages. The figures also illustrate that the overall process described herein eliminates the need for manual 3D modeling while maintaining high-quality photorealistic output, while reducing the time and resource requirements typically associated with lifestyle image creation while ensuring consistent, high-quality results across different scene types and product categories.

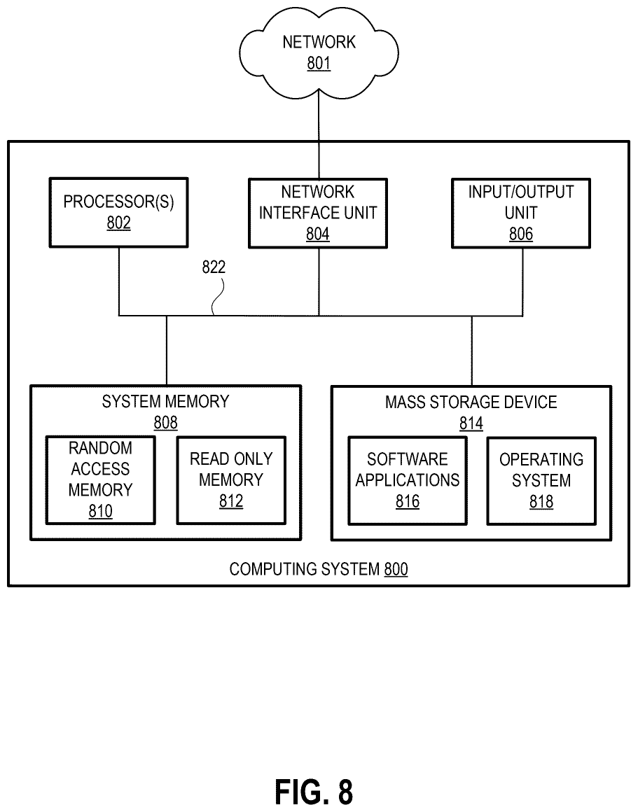

FIG. 8 illustrates an example block diagram of a virtual or physical computing system 800. One or more aspects of the computing system 800 can be used to implement the systems described herein, store instructions described herein, and perform operations described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 801. The network 801 is a computer network, such as an enterprise intranet and/or the Internet. The network 801 can include a LAN, a Wide Area Network (WAN), the Internet, wireless transmission mediums, wired transmission mediums, other networks, and combinations thereof. The computing system 800 may connect to the network 801 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

FIG. 9 illustrates a diagram 900 showing a difference between product masks for an inpainting process. For example, as shown by the diagram 900, a mask of an actual product image is overlayed on an object identified in a generated image as corresponding to the actual product image. For example, the diagram 900 may show the dimensional difference between the vase in the updated structure image 602, which shows an image of an actual product to be integrated into a scene, and the vase in the initial generated image 606, which may be generated by the control net model 105 based in part on the control image 604.

As shown, when the actual product image is placed into the generated image, there are pixels corresponding to the replaced object that are not covered due to dimensional differences between the products. This is shown by the exposed white pixels corresponding to the object that is to be replaced. Accordingly, the platform 100 can apply the inpainting model 106 to modify the colors of pixels that are not covered by the actual product image. For example, the inpainting model 106 may determine average color values of nearby pixels and then modify the pixels of the generated scene at these locations to be the average colors, thereby creating a visually smooth transition between the product image and the visual context into which it is placed.

FIG. 10 is a flowchart of an example method 1000 that may be executed by the user 14. For example, the user 14 may use the application 12 to perform aspects of the method 1000. In some embodiments, the user 14 may use features of the user interface 1100, which is further described below, to perform the method 1000. The user 14 may be, for example, an advertiser or product developer. In some embodiments, the method 1000 is performed by a third-party user that accesses the platform 100 to generate scenes.

In the example shown, the user 14 can input a scene image (step 1002). As an example, the platform 100 may make available a plurality of template images from which the user 14 may select. The template images may serve as a basis for the scene that the user seeks to generate and may provide the context and physical spacing between objects in the scene into which products images are to be integrated. The scene may be selected from among the product images 20. The plurality of template images may conform to a style of an entity associated with the platform to ensure visual consistency of images associated with the entity. As another example, the user 14 may upload a scene or may generate a scene using AI or other image generation technology.

In the example shown, the user 14 may input a product (step 1004). For example, the user 14 can input one or more images of one or more products that are to be integrated into the scene image. In some embodiments, the user 14 may also drag and drop—or otherwise insert—the images of the products into the scene image at a position in which the user 14 wants the products to be located. Additionally, the user 14 may manipulate one or more of a rotation or dimension of the product images to match its position within the scene image. In some embodiments, the user 14 inputs a product identifier or name, and the platform 100 automatically retrieves images that are mapped to the product identifier or name and inserts the images into the scene image.

In the example shown, the user may input a prompt (step 1006). For example, the prompt may instruct the platform 100 regarding how the scene is to be generated with the one or more products integrated therein. In some embodiments, the prompt can include modifications to the scene image, such as to incorporate the one or more product images. In some instances, a prompt is not provided by the user 14, and the platform 100 can automatically select a prompt associated with the scene image or one or more products. For example, the prompt may be text associated with the one or more input products.

One or more of the scene image, the one or more products, or the prompt can be provided to the platform 100. In response, the platform 100 can generate a scene that includes the products integrated therein, example aspects of which are described in connection with FIGS. 2-7. In some embodiments, the platform 100 can generate a plurality of scenes with the products placed therein. For example, the platform 100 can apply different hyperparameter values in the control net model 105 to generate different versions of the scene into which the product is placed.

In the example shown, the user 14 can receive a plurality of generated scenes from the platform 100 (step 1008). For example, the user 14 can receive a generated scene after the products have been integrated therein and inpainting and other image modifications have been performed. The plurality of generated scenes can represent options of scenes that include the products input by the user 14.

In the example shown, the user 14 can select a generated scene from the plurality of generated scenes (step 1010). For example, the user 14 can receive multiple variations of the generated scene with the products integrated therein, such as scenes generated using varying hyperparameter values, and the user 14 can select a scene from among the multiple variations.

In the example shown, the generated scene selected by the user can be displayed (step 1012). As an example, the generated scene can be displayed as part of an application that advertises the one or more products input by the user. For example, the scene may be displayed on a website or mobile application advertising the product or on a product details page for the one or more products.

FIG. 11 illustrates an example user interface 1100. The user interface 1100 may be part of an application that is communicatively coupled with the platform 100. For example, the user interface 1100 may be part of the client application 12. The user 14 may interact with the user interface 1100 using the device 10. In the example shown, the user interface 1100 includes an inputs region 1102, a processing parameters region 1104, and a generated scene region 1106. In some embodiment, components of the user interface 1100 can be distributed across a plurality of user interfaces, and the user interface 1100 can include more or fewer components than illustrated in FIG. 11.

The user interface 1100 includes various input and output fields. The form of each input field may vary depending on the embodiments. For example, regarding the input fields in the input region 1102 and the processing parameters region 1104, the input fields may include one or more of the following: text fields; radio buttons; check boxes; drop-down menus; file upload fields; search bars; toggle switches; range sliders; drag-and-drop fields; a combination thereof; or other input fields.

The inputs region 1102 includes a plurality of input fields for the user 14 to input data for generating a scene. In the example shown, the inputs region 1102 includes a field for the user 14 to input a template scene. For example, as described further in connection with FIG. 10, the user 14 can drag-and-drop, generate, or otherwise provide a scene to serve as a basis for the generated scene. In an example, the user selects from a plurality of options of template scenes that are pre-approved in the platform 100, retrieved from the scene images 22, and displayed by the user interface 1100.

The inputs region 1102 further includes a field for the user to input a prompt. In an example, the user 14 may write a text prompt. As another example, the user 14 may select from among a plurality of pre-approved prompts associated with the template scene or a product provided by the user 14. The inputs region 1102 further includes input fields for the user 14 to input products to integrate into the scene. In the example shown, the user 14 has selected the “curved vase” and the “landscape mix” products. For example, the user 14 may select these items from a catalog that is accessible via the user interface 1100. Furthermore, the user 14 can select one or more photos associated with each of these products, as shown in the user interface 1100. In some embodiments, the user 14 indicates locations in which the product photos are to be integrated into the provided template scene. For example, the user 14 can use the user interface 1100 to drag-and-drop the product images into locations in the template scene or select pixels within the template scene as corresponding to locations into which the product images are to be inserted.

The processing parameters region 1104 includes a plurality of inputs fields for the user 14 to input data to be used by the platform 100 when generating a scene. The processing parameters region 1104 includes an input field for selecting a format of the control image used by the platform 100. Example formats include edge images or Canny images, key point images, color images, three-dimensional images, a sketched image, a map identifying key boundaries, or another type of conditioning image that can be used by the control net model 105. In some embodiments, the selection of the image type dictates the model that is used as part of the control feature detector 102. For example, if an edge image or Canny image is selected, then the control feature detector 102 may apply a Canny edge detector model. In some embodiments, the selection of the control image format also dictates the format of the structure images used by the platform 100.

The processing parameters region 1104 further includes an input field for selecting an image generation model. For example, the user 14 can select a specific model for one or more of the diffusion model 104 or the control net model 105. In some embodiments, the user interface 1100 includes a drop-down list of models that are accessible to the platform 100. The processing parameters region 1104 further includes an input field for selecting hyperparameter values. The hyperparameter values can be used by a model during image generation. In the example shown, the user 14 can input weights that are used by the control net model 105. For example, the higher the value input for the prompt, the more strictly the control net model 105 will adhere to the prompt input via the region 1102, and the higher the value input for the control image, the more strictly the control net model 105 will adhere to the control image that is generated by the control feature detector 102. In some embodiments, these hyperparameters are selected using a sliding toggle between ranges that are approved by the platform 100 and displayed in the user interface 1100.

The processing parameters region 1104 further includes an input field to select a number of scenes to generate. For example, if the user 14 were to select three scenes, then the platform 100 would generate three variations of a scene that include the input products integrated therein, and the user 14 would be able to select a particular scene from among the three scenes. In the example shown, the user 14 selects that one scene is to be generated. In some embodiments, one or more of the input fields of the processing parameters region 1104 are pre-filled and may not be modifiable by the user 14.

The generated scene region 1106 displays one or more scenes generated by the platform 100. Furthermore, the generated scene region 1106 includes one or more options. For example, the user 14 may select the generate scene button 1108. In response, the platform 100 may use data from the inputs region 1102 and the processing parameters region 1104 to generate the scene displayed in the generated scene region. As another example, the user 14 may select the modify image button 1110. In response, the user interface 1100 can launch an application that enables the user 14 to modify the image output in the generated scenes region 1106, thereby allowing the user 14 to fix any visual discrepancies in the generated image that may have occurred when the platform 110 generated the image. As another example, the user 14 may select the publish button 1112. In response, the application displaying the user interface 1100 can provide the generated image to a downstream application. For example, the image can be provided to a digital retail system to display the image on a website or mobile application. As another example, the image can be printed and displayed in one or more of a catalog, advertisement, or other print media.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A system for automated scene generation, comprising:
a control feature detector configured to generate a control image from a structure image containing product images;
a control net model configured to generate a scene based on a text prompt and the control image;
a segmentation model configured to:
extract a mask from the structure image; and
extract a second mask from the generated scene;
an inpainting model configured to correct dimensional differences between objects in the generated scene and the product images;
wherein the system is configured to:
overlay a product image onto the generated scene using the mask and the second mask; and
process the generated scene to maintain lighting consistency and shadow effects on the product image within the generated scene.

2. The system of claim 1,
wherein the structure image comprises an edge image with the product image overlaid on the edge image;
wherein the control feature detector comprises a canny edge detector model; and
wherein the canny edge detector model generates the control image by detecting edges of the product image.

3. The system of claim 1, wherein the segmentation model comprises a Segment Anything Model (SAM).

4. The system of claim 1, wherein the control net model comprises a stable diffusion model with ControlNet.

5. The system of claim 1, wherein the structure image comprises:
a structure reference for the control net model; and
the product images positioned at desired locations within the structure reference.

6. The system of claim 1, wherein the system is further configured to receive the text prompt describing scene characteristics including at least one of: object specifications, lighting requirements, shadow characteristics, and material properties.

7. The system of claim 1, wherein the system is configured to:
generate the control image from the structure image;
generate the scene using the control net model;
extract the mask from the structure image and the second mask from the generated scene; and
inpaint the generated scene to correct dimensional differences between the mask and the second mask.

8. The system of claim 1, wherein the system is configured to:
identify pixels covered by the second mask but not the mask; and
apply the inpainting model to modify colors of the pixels covered by the second mask but not the mask.

9. The system of claim 1, wherein the system is configured to:
process multiple products sequentially within a single scene while maintaining the lighting consistency across the scene.

10. The system of claim 1, wherein the system is configured to:
automatically generate lifestyle imagery featuring product placements without requiring manual 3D product modeling.

11. A method for automated scene generation, comprising:
receiving a text prompt describing desired scene characteristics and a structure image containing product images;
generating, using a control feature detector, a control image from the structure image;
generating, using a control net model, a scene based on the text prompt and the control image;
extracting, using a segmentation model:
first masks from the structure image, and
second masks from the generated scene;
overlaying the product images onto the generated scene using the first masks and second masks; and
sequentially processing each overlaid product using an inpainting model to correct dimensional differences between objects in the generated scene and the product images while maintaining visual effects within the generated scene.

12. The method of claim 11, wherein the visual effects include lighting consistency and shadow effects.

13. A method for integrating products into generated scenes, comprising:
receiving a structure reference containing control features and positioned product images;
detecting control features from the structure reference to create a control image;
generating a scene using a control model and a text prompt;
segmenting products from the structure reference and objects from the generated scene to create masks;
replacing generated objects with product images using the masks; and
applying inpainting to correct dimensional differences between the generated objects and the product images.

14. The method of claim 13,
wherein the control features comprise edges in a structure image; and
wherein the positioned product images are overlayed in the structure image.

15. The method of claim 13, wherein segmenting the products from the structure reference and the objects from the generated scene to create masks comprises:
identifying first pixel locations, in the structure image, of the positioned product images; and
identifying second pixel locations, in the generated scene, of objects corresponding to the positioned product images.

16. The method of claim 13, further comprising:
receiving a first hyperparameter value for the text prompt; and
receiving a second hyperparameter value for the control image;
wherein generating the scene comprises generating the scene using a control net, wherein the control net weighs the text prompt using the first hyperparameter value and wherein the control net weighs the control image using the second hyperparameter value.

17. The method of claim 13, further comprising:
generating a plurality of scenes integrating the positioned product images, wherein each scene of the plurality of scenes is generated based at least in part on the control image; and
outputting the plurality of scenes to a client application for selection of one of the plurality of scenes by a user.

18. The method of claim 13, wherein applying inpainting comprises:
identifying pixels for which a first mask segmented from the structure reference and a second mask segmented from the generated scene do not overlap; and
modifying colors of the pixels based on average color values of neighboring pixels in the generated scene.

19. The method of claim 13, wherein the text prompt comprises a text description of a product depicted by the positioned product images, wherein the text description is retrieved from a product catalog.

20. The method of claim 13, further comprising, after applying inpainting, displaying the generated scene in one or more of a retail website or mobile application.
